(19) United States
(12) Patent Application Publication
(10) Pub. No.: US 2003/0198240 A1
(43) Pub. Date: Oct. 23, 2003

(54) Data-receiving port and method for programmable updating of available buffer space information in a communications channel

(76) Inventor: Edmundo Rojas, Fort Collins, CO (US)

Correspondence Address: AGILENT TECHNOLOGIES, INC., Legal Department, DL429, Intellectual Property Admininstration, P.O. Box 7599, Loveland, CO, 80537-0599, US

(21) Appl. No.: 10/125,154

(22) Filed: Apr. 17, 2002

(51) Int. Cl. H04L 12/28; H04L 12/56

(52) U.S. Cl. 370/412; 370/428

(57) ABSTRACT

A data-receiving port and method according to embodiments of the invention allow information concerning available buffer space in the receiving port of a communications channel to be transferred to a sending port. The timing of the information transferred can be programmed to depend on the status of previous data transfers from the sending port. This programmability allows the information transfers from the receiving port to be tailored to the specific characteristics of the data traffic being serviced. Therefore, the tradeoff between having enough information being transferred to a sending port to keep it apprised of the state of the buffer, and limiting that information so that data traffic from the receiving port to the sending port is not significantly impacted, can be managed effectively.

### BACKGROUND OF THE INVENTION

Many computer systems employ the use of a data buffer to temporarily store data passing through the system. In a typical scenario, such a system receives data into a data buffer by way of a communications port that is part of a communications channel, and then transfers that same data by way of the same or another port. The port may be connected to other portions of the same computer system, or to remote computer systems. The data being transferred may be associated with data storage systems, local area network (LAN) servers, Internet servers, and the like.

An example of a typical communications channel 100 is shown in FIG. 1. Such a communications channel 100 may be, for example, a “virtual lane” as utilized in the InfiniBand™ Architecture (IBA), a technical specification supported by the Infiniband^{SM} Trade Association, which defines a point-to-point, switched-fabric input/output (I/O) channel for connecting computers, network servers, storage subsystems, and other devices that require intercommunication. FIG. 1 indicates data flowing in simplex mode (one-way data transfers, all in a single direction) to simplify the following discussion, but most communications channels 100 allow two-way data transfer, in either half-duplex (one-way data transfers in either direction) or full-duplex (simultaneous data transfers in both directions) mode.

Referring to FIG. 1, a receiving port 110 and a sending port 120 are connected in some fashion, such as by copper wire, printed wire on a circuit board, optical link, or any other means acceptable for a particular application. The ports 110, 120 may reside within computers, servers, computer peripherals, network switches, and the like. The sending port 120 is responsible for sending incoming data 130 to be stored in a data buffer 150 of the receiving port 110. The data stored in the data buffer 150 are subsequently transferred as outgoing data 140, which are then transferred out the same receiving port 110 or another port (not shown) to another external device, consumed internally by the device containing the receiving port 110, or disposed of in some other fashion. With respect to the IBA, data is organized into “packets”, which are quantized blocks of data of some standard size. Data are packetized in many types of systems to define the minimum amount of data to be transferred at any one time. Such packets may also be retransferred from one port to another in the case the data packets did not reach the intended destination successfully.

A long-standing problem with such a communications channel 100 is that the data buffer 150 is of limited size, and so may become full with incoming data 130 yet to be transferred as outgoing data 140. As a result, the sending port 120 may be unnecessarily sending incoming data 130 that cannot be stored in the data buffer 150. In an effort to remedy this situation, some communications channels 100 employ buffer space updates 160 that are transferred periodically from the receiving port 110 to the sending port 120 to indicate the amount of storage space currently available in the data buffer 150 that may be used to store incoming data 130. With respect to the specific example of the IBA, the buffer space updates 160 are termed flow control (FC) packets. The sending port 120 utilizes the information contained in the buffer space updates 160 to keep track of how much space is available in the data buffer 150 for more incoming data packets 130. The sending port 120 typically alters a local copy this information internally by subtracting from the amount of space available an appropriate amount for every amount of incoming data 130 it sends thereafter to the data buffer 150. Once the sending port 120 believes it has used up all of the available space in data buffer 150, it likely will cease sending more incoming data 130 until it receives another buffer space update 160 indicating more space is available. In the IBA, for example, the FC packets are required to be sent by the receiving port 110 at least once per some maximum time period stated in the IBA specification. A maximum time period is utilized to prevent an extended lock-up of the communications channel 100 due to a lack of FC packets that would otherwise indicate that some of the data in the data buffer 150 has been removed as outgoing data 140, thus freeing up more available space for incoming data 130.

A potential problem with generating buffer space updates 160 in this manner is that the sending port 120 may not be sending incoming data 130 during times when available space exists in the data buffer 150, thus reducing the overall data rate attainable over the communications channel 100. Such a problem can be mitigated by the receiving port 110 issuing buffer space updates 160 to the sending port 120 more frequently. However, the sending of buffer space updates 160 consumes bandwidth that could be used for sending data (not shown in FIG. 1) from the receiving port 110 back to the sending port 120. The more often the buffer space updates 160 are sent, the more bandwidth that is potentially wasted as a result.

Therefore, from the foregoing, a new method that allows for balancing the need for more frequent updating of buffer space information with the desire to limit the amount of bandwidth consumed by such information being transferred over a communications channel would be advantageous.

### SUMMARY OF THE INVENTION

Embodiments of the present invention, to be discussed in detail below, represent a receiving port and method that allow buffer space updates from the receiving port of a communications channel to be transferred to a sending port, with the timing of the transfer of the updates programmed to depend on the status of previous data transfers from the sending port.

The programmability of the timing allows the transfers of the buffer space updates from the receiving port to be tailored to the specific characteristics of the data traffic being serviced. As a result, an acceptable tradeoff can be attained between having enough updates being transferred to a sending port to keep it apprised of the state of the buffer, and limiting the updates so that data traffic from the receiving port to the sending port is not significantly impacted.

Other aspects and advantages of the invention will become apparent from the following detailed description, taken in conjunction with the accompanying drawings, illustrating by way of example the principles of the invention.

### BRIEF DESCRIPTION OF THE DRAWINGS

FIG. 1 is a block diagram of a communications channel from the prior art.

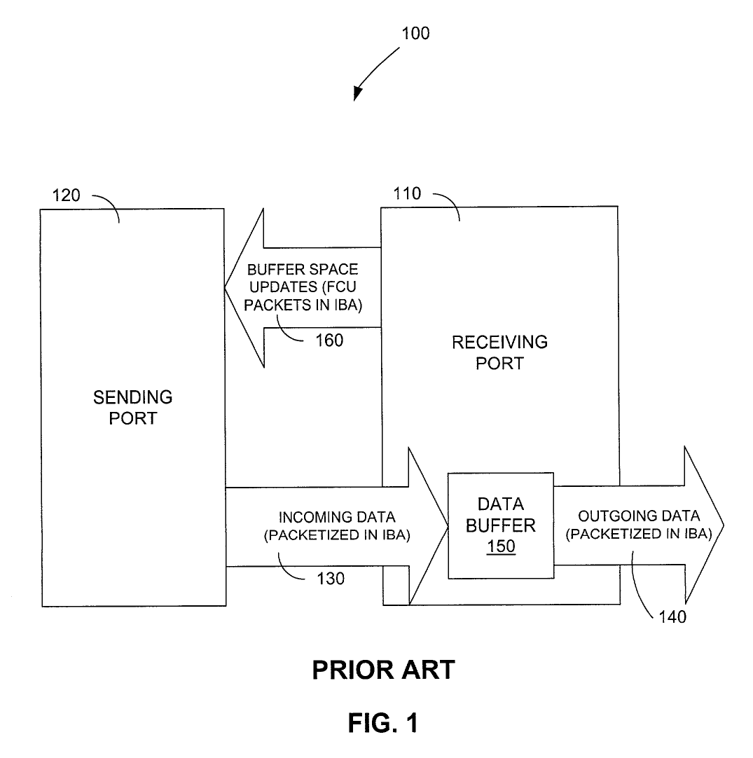

FIG. 2 is a block diagram of a communications channel utilizing a receiving port according to an embodiment of the invention.

FIG. 3 is a block diagram describing a possible data structure for controlling the transfer of buffer space information from a receiving port according to an embodiment of the invention.

FIG. 4 is a flowchart describing a method according to an embodiment of the invention of updating a sending port of the available data buffer space in the receiving port.

### DETAILED DESCRIPTION OF THE PREFERRED EMBODIMENTS

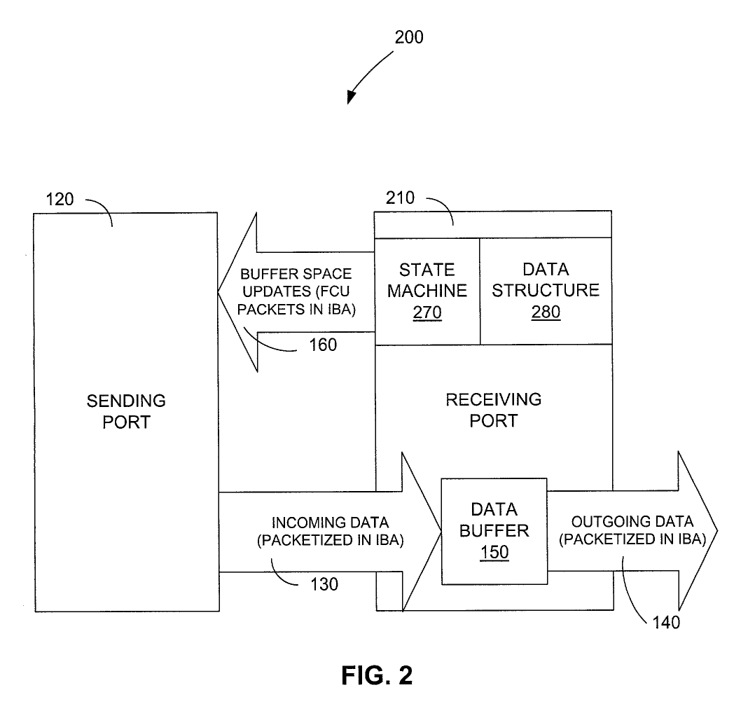

A block diagram of one embodiment of the invention, a receiving port 210 of a communications channel 200, is shown in FIG. 2. Along with a data buffer 150 that is utilized to store incoming data 130 from a sending port 120, the receiving port 210 also contains a state machine 270 that determines when buffer space updates 160 are transferred to the sending port 120 to inform it of the current amount of space in the data buffer 150 that is available for more incoming data 130. The state machine 270 causes the generation and transfer of the buffer space updates 160 to the sending port 120 based on the status of previous transfers of incoming data 130 from the sending port 120. As more specifically detailed below, the status of previous incoming data transfers could include, but is not limited to, whether the previous data transfer completed successfully, and whether the previous data transfer was able to fit in the data buffer 150. Also, the frequency of the buffer space updates 160 may be limited in spite of the status of previous transfers of incoming data 130 by way of some predetermined threshold so that the bandwidth consumed by the buffer space updates 160 may be managed effectively.

The state machine 270 may be implemented in dedicated hardware circuitry, in software that is executed on a microprocessor, microcontroller, or similar algorithmic controller, or any other appropriate means available in the art.

The state machine 270 employs a programmable data structure 280, which may be implemented in hardware or software, that indicates which types of status of previous incoming data transfers 130 are to be utilized in determining when the buffer space updates 160 are generated and transferred to the sending port 120. For example, the programmable data structure 280 can be employed to select none, one or more of the various types of status of the incoming data transfers 130 mentioned above to control the transfer of the buffer space updates 160. A more specific example of such a data structure 280 is discussed below.

A specific embodiment of the invention is a receiving port 210 for an IBA virtual lane. In that environment, incoming data 130 and outgoing data 140 are organized in packets. Also, the buffer space updates 160 are implemented as FC packets. Also, as mentioned earlier, the FC packets are typically sent in response to a timeout limit, which according to the IBA specification can be no longer than 65536 “byte clocks”, which are a unit of time measure in an I/O connection structured according to the IBA.

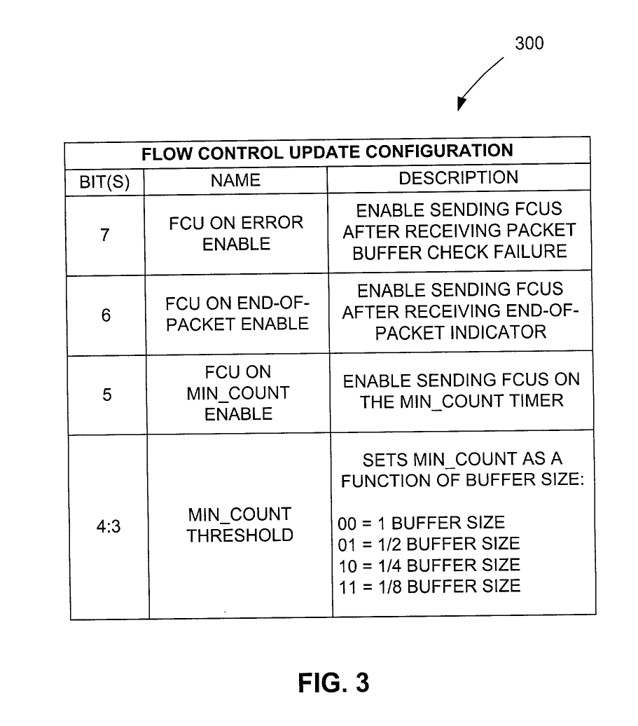

One embodiment of the present invention applicable to the IBA utilizes a flow control update (FCU) configuration data structure 300 of FIG. 3, which is a specific example of the data structure 280 of FIG. 2 as applied to the IBA. In this embodiment, several bits of a programmable IBA “Port Configuration” vendor-specific register supply the necessary data structure 280 required for the state machine 270. The data structure 280 may be programmed by way of an electronic device containing the receiving port 210, or any electronic device remote to the receiving port 210 that is configured to communicate with the receiving port 210. Also, in the following discussion, the identity of the bits used, as well as the particular register employed, are not critical to the functionality of the embodiment.

In the example of FIG. 3, FCU configuration data structure 300 allows the use of three different types of status of previous incoming data 130 to determine when an FC packet should be transferred to the sending port 120. For example, bit 7, when programmed, enables FC packets to be transferred to the sending port 120 whenever a “packet buffer check failure” occurs. This situation arises in the IBA when an overflow condition of the data buffer 150 occurs, indicating that the last transfer of incoming data packets was too large to be placed in the space available in the data buffer 150. The overflow condition typically occurs when the actual amount of space available in the data buffer 150 is less than that expected by the sending port 120 prior to the last transfer of incoming data 130. Transferring an FC packet in that case informs the sending port 120 of the correct amount of space available in the data buffer 150, thereby allowing the sending port 120 to reallocate the amount of buffer space it would have considered to be consumed by the previous data transfer. In other words, if an FC packet were not transferred in this case, the local copy of the FC information held by the sending port 120 may indicate less space available in the data buffer 150 than what actually exists at that time.

Bit 6, when programmed, allows the receiving port 210 to transfer an FC packet at the end of every received incoming data packet. This event is signaled in the IBA by way of an “end-of-packet” indicator transferred by the sending port 120 at the end of each packet of incoming data 130. In cases where data packets are sent in short bursts, and are then quickly forwarded as outgoing data packets 140, transferring FC packets in this manner allows the sending port 120 to be kept apprised of the amount of space available in the data buffer 150. Thus, the sending port 120 will not falsely assume that the data buffer 150 is full, thus preventing more incoming data packets 130 from being transferred by the sending port 120.

Bit 5, when programmed, provides an upper limit on the frequency of transferred FC packets, thus limiting the amount of bandwidth consumed with such packets. When enabled, this bit prevents an FC packet from being sent until the period of time, as measured in byte clocks, since the last FC packet has reached a predetermined threshold. This threshold is designated in FIG. 3 as “min_count”. In the data structure 300, that threshold period of time is specified in terms of the time required to fill a fraction of the size of data buffer 150 with incoming data 130, as indicated by bits 4 and 3 of the FCU configuration data structure 300. For example, if bit 5 is set to ‘1’, and bits 4 and 3 are set to ‘10’, an FC packet will not be transferred unless the length of time since the last FC packet sent is equivalent to the length of time necessary to fill one-quarter of the size of the data buffer 150.

In some embodiments, the period of time to which the predetermined threshold applies may not begin until incoming data 130 or outgoing data 140 are transferred into or out of the data buffer 150. The advantage of such embodiments would be to further reduce the number of FC packets sent unnecessarily during times when no data transfers are occurring.

In alternate embodiments, the threshold may be stated in terms of the amount of data, or number of data packets, that have been transferred into or out of the data buffer 150 since the last FC packet was transferred to the sending port 120.

From the previous discussion, it can be seen that some bits of the FCU configuration data structure 130, when programmed, cause the FC packets to be sent at an increased rate that what would normally be allowed under a simple time-based algorithm. Alternately, bit 5, in conjunction with bits 4 and 3, act to place an upper limit on the frequency of the FC packets. As a result, any combination of programming these bits may be utilized to tailor the number and frequency of FC packets for the particular application involved. Additionally, other types of status associated with incoming data transfers 130 may be employed to modify how the state machine 270 determines when to transfer buffer space updates 160, either in the general case, or the specific application of an IBA I/O channel. Furthermore, a standard time limit, such as the above mentioned byte count of the IBA, may also be used in conjunction with the status of the previous data transfer in determining when a buffer space update 160 is generated.

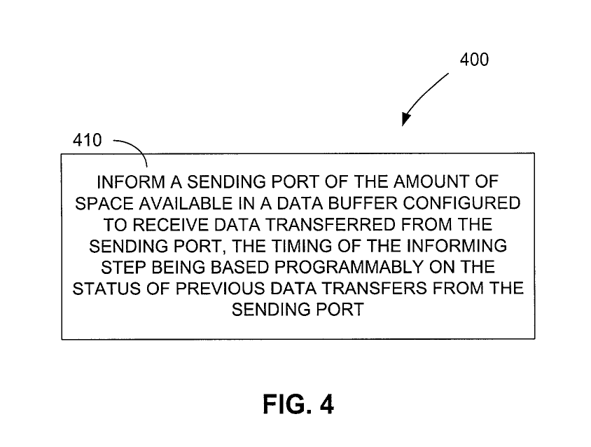

The invention herein disclosed is also embodied as a method of programmably controlling data flow in a communications channel. As displayed in FIG. 4, a method 400 according to an embodiment of the invention involves informing a sending port of the amount of space available in a data buffer configured to receive data from the sending port, with the timing of the informing step being based programmably on the status of previous data transfers from the sending port (step 410). The status of the previous data transfers that are used at any particular time in determining when the informing step occurs may include, but is not limited to, whether the previous data transfer completed successfully, and whether the previous data transfer was able to fit in the data buffer. Also, the frequency of the informing step may be limited by way of a predetermined threshold so that the amount of bandwidth consumed by the information step may be effectively managed.

With respect to the specific instance of an I/O channel of the IBA, data is transferred in packets, and the informing step is performed by way of the transfer of an FC packet to the sending port. According to method embodiments of the invention pertaining to IBA, the timing of the informing step is determined programmably from the status of previous transfers of data packet to the sending port, including, but not limited to, whether the previous data packet transferred fit in the data buffer, and whether the transfer of the previous data packet completed successfully. Also, the frequency of the informing step may be limited by whether the period of time since the last FC packet was transferred has reached some predetermined threshold.

From the foregoing, the embodiments of the invention discussed above have been shown to provide a data-receiving port and method for programmably controlling data flow in a communications channel. In addition, other specific ports and methods embodying the invention are also possible. Therefore, the present invention is not to be limited to the specific forms so described and illustrated; the invention is limited only by the claims.

What is claimed is:

1. A receiving port of a communications channel, comprising:
a data buffer configured to receive data transferred from a sending port;
a state machine configured to generate buffer space updates to be transferred to the sending port, the buffer space updates indicating the amount of space available in the data buffer; and
a programmable data structure utilized by the state machine to control the timing of the generation of the buffer space updates based on the status of previous data transfers from the sending port.

2. The receiving port of claim 1, wherein the data structure may be programmed so that at least one of the buffer space updates is transferred to the sending port when data previously transferred from the sending port does not fit into the available space in the data buffer.

3. The receiving port of claim 1, wherein the data structure may be programmed so that at least one of the buffer space updates is transferred to the sending port when data previously transferred from the sending port was received into the data buffer.

4. The receiving port of claim 1, wherein the data structure may be programmed so that the period of time elapsed between successive buffer space updates is no less than a predetermined threshold.

5. The receiving port of claim 1, wherein the data transferred from the sending port is in the form of data packets, and the buffer space updates are flow control (FC) packets.

6. The receiving port of claim 5, wherein the data structure may be programmed so that at least one of the FC packets is transferred to the sending port when a data packet previously transferred from the sending port did not fit into the available space in the data buffer.

7. The receiving port of claim 5, wherein the data structure may be programmed so that at least one of the FC packets is transferred to the sending port when a data packet previously transferred from the sending port was received into the data buffer.

8. The receiving port of claim 5, wherein the data structure may be programmed so that the period of time elapsed between successive FC packets is no less than a predetermined threshold.

9. A communications channel, comprising the receiving port of claim 1.

10. A method of programmably controlling data flow in a communications channel, the method comprising the step of:
informing a sending port of the amount of space available in a data buffer configured to receive data transferred from the sending port, the timing of the informing step being based programmably on the status of previous data transfers from the sending port.

11. The method of claim 10, wherein the informing step may occur when data previously transferred from the sending port did not fit into the available space in the data buffer.

12. The method of claim 10, wherein the informing step may occur when data previously transferred from the sending port was received into the data buffer.

13. The method of claim 10, wherein the period of time elapsed between successive instances of the informing step is no less than a predetermined threshold.

14. The method of claim 10, wherein the data transferred from the sending port is in the form of data packets, and the informing step is accomplished by way of flow control (FC) packets.

15. The method of claim 14, wherein at least one of the FC packets may be transferred to the sending port when a data packet previously transferred from the sending port did not fit into the available space in the data buffer.

16. The method of claim 14, wherein at least one of the FC packets may be transferred to the sending port when a data packet previously transferred from the sending port was received into the data buffer.

17. The method of claim 14, wherein the period of time elapsed between successive FC packets is no less than a predetermined threshold.
